(19) United States
(12) Patent Application Publication
(10) Pub. No.: US 2009/0101871 A1
(43) Pub. Date: Apr. 23, 2009

(54) SOLID SALT PREPARATION, THE PRODUCTION THEREOF AND ITS USE

(75) Inventors: Stefan Fokken, Biberbach (DE); Frank Reichwald, Munich (DE)

Correspondence Address: WOOD, HERRON & EVANS, LLP, 2700 CAREW TOWER, 441 VINE STREET, CINCINNATI, OH, 45202, US

(73) Assignee: Baerlocher GmbH, Unterschleissheim (DE)

(21) Appl. No.: 11/994,737

(22) PCT Filed: Jul. 5, 2006
(86) PCT No.: PCT/EP2006/006572

§ 371 Date: Jul. 10, 2008

(30) Foreign Application Priority Data
Jul. 6, 2005 (DE) 102005031624.7

(51) Int. Cl. C09K 15/32; C09K 3/00; C08K 3/16; C08K 3/10

(52) U.S. Cl. 252/400.61; 252/182.35; 252/182.32; 524/436; 524/401; 252/400.62

(57) ABSTRACT

The present invention relates to a solid salt preparation with improved ease of handling, which comprises a mixture composed of a salt of a halogen-containing oxy acid and of a solvent. The present invention further relates to a process for the production of these salt preparations and also to their use, in particular in stabilizer compositions for halogen-containing polymers.

The present invention relates to a solid salt preparation with improved ease of handling, which comprises a mixture composed of a salt of a halogen-containing oxy acid and of a solvent. The present invention further relates to a process for the production of these salt preparations and also to their use, in particular in stabilizer compositions for halogen-containing polymers.

It is known that when halogen-containing plastics are exposed to heat during processing or in long-term use they have a tendency toward undesired decomposition reactions and undesired degradation reactions. Degradation of halogenated polymers, in particular PVC, produces hydrochloric acid which is eliminated from the polymer chain, the result being a discolored, unsaturated plastic with polyene sequences that generate color.

In particular when moldings have exposure to light, or temperature cycles or other external effects, changes in color and in the properties of the material occur as service time increases, and can sometimes proceed to the extent that the molding becomes unserviceable.

Various stabilizer systems have been proposed for stabilizing halogen-containing polymers with regard to long-term damage resulting from exposure to light or heat. For example, the prior art describes systems which comprise perchlorate salts for the stabilization of halogen-containing polymers.

However, a frequent disadvantage with the systems described is that the desired stabilizing action cannot be achieved in every application involving the polymers to be stabilized. The stabilizing action is often insufficient to meet the relevant requirements.

Another problem arising with the use of perchlorate salts is that these unstable oxidants usually have to be handled very carefully in order to avoid damage to the health of personnel, or damage to materials, for example resulting from explosions. Users therefore often have reservations with regard to the use of perchlorate salts in stabilizer compositions. Various methods have therefore been proposed for improving the ease of handling of these perchlorate-containing stabilizer compositions.

By way of example, EP-B 0 457 471 describes a stabilizer composition which comprises perchlorate, calcium silicate and calcium carbonate. To produce the stabilizer compositions described, an aqueous solution of sodium perchlorate is mixed with calcium silicate or with a mixture composed of calcium silicate and calcium carbonate. A problem arising with the stabilizer compositions described is that they retain crystallites of sodium perchlorate. These crystallites can, as described above, sometimes generate problems during handling. Furthermore, these stabilizer compositions sometimes cannot be incorporated homogeneously within a halogen-containing polymer to be stabilized. Furthermore, the presence of a carrier material often restricts stabilizer action when comparison is made with other stabilizer compositions. Furthermore, the calcium silicate used in the case described has high Moh hardness, and this can sometimes cause lasting damage to processing plants.

A need therefore existed to improve the performance of stabilizer compositions which comprise a salt of a halogen-containing oxy acid. In particular, a need existed to improve the performance of stabilizer compositions which comprise a salt of a halogen-containing oxy acid with respect to the thermal stability of the halogen-containing polymers to be stabilized.

Because of the problems in relation to the use of handling a perchlorate salt and of preparations based on these, there was also a need for preparations of this type which comprise a salt of a halogen-containing oxy acid in a finished product which markedly reduces risk when these perchlorate salts are used.

Although the prior art discloses preparations which comprise perchlorate salts in the form of a liquid solution in water or, for example, butyl diglycol, possibilities for using these liquid preparations are in many cases restricted, for example in stabilizer compositions for halogen-contained polymers. In many cases, formulators of these stabilizer compositions wish to add appropriate perchlorate salts to the stabilizer composition in solid form, i.e. in the form of solid salt preparations, in order to maximize freedom of formulation for adjustment of the consistency of the stabilizer composition. Liquid perchlorate salts often fail to meet this requirement.

An object on which the present invention is based is therefore to provide these solid salt preparations and stabilizer compositions based on these, and also processes for their respective production.

The objects underlying the invention are achieved via salt preparations and stabilizer compositions which comprise these salt preparations, and also processes for their production, as described in the text below.

The present invention provides salt preparations which permit simple handling of perchlorate salts. However, the inventive advantages extend beyond the handling of perchlorate salts and are in principle achieved with all of the salts of halogen-containing oxy acids, including, for example, chlorites, hypochlorites, chlorates, bromates, iodates, perbromates and the like.

The present invention therefore provides a salt preparation at least comprising a salt of a halogen-containing oxy acid or a mixture composed of two or more salts of halogen-containing oxy acids and a solvent or a mixture composed of two or more solvents, where the salt of a halogen-containing oxy acid or the mixture composed of two or more salts of halogen-containing oxy acids is soluble in the solvent or the mixture composed of two or more solvents at 20° C. to an extent of at least 0.1% by weight, based on the solvent or the mixture composed of two or more solvents, and the salt preparation is solid at 5° C. In further embodiments, an inventive salt preparation is solid at 80° C. or at 60° C. or at 50° C. or at 40° C. or at 30° C. or at 20° C. or at 10° C. or at 5° C. or at 0° C.

An inventive salt preparation therefore has at least two constituents. An inventive salt preparation comprises, as a first constituent, at least one salt of a halogen-containing oxy acid, in particular a perchlorate of the general formula M(ClO₄)ₖ, where M is a suitable inorganic or organic cation. The index k is the number 1, 2 or 3, as a function of the valency of M. Examples of inorganic cations M suitable in the invention are Li, Na, K, Mg, Ca, Sr, Zn, Al, La, Ce, or NH₄.

Examples that may be mentioned of organic cations M suitable in the invention are organic onium ions, and the expression “organic onium ion” here means for the purposes of the present text ammonium ions, sulfonium ions or phosphonium ions, each bearing at least one organic moiety. A corresponding onium salt of the present invention can, as a function of the nature of the onium group here, bear 1, 2, 3 or 4 organic moieties. The organic moieties here can, for example, have bonding by way of a C—X linkage, where X is N, S or P, to a positively charged N atom, S atom or P atom of an inventive onium ion. However, it is equally possible that the organic moieties have bonding by way of a further heteroatom, for example an O atom, to a positively charged N atom, S atom or P atom of an inventive onium ion.

An onium perchlorate suitable for the purposes of the present invention as a constituent of an inventive salt preparation has, for example, a positively charged N atom, S atom or P atom, or two or more of these positively charged N, S or P atoms or a mixture composed of two or more of the positively charged atom types mentioned.

For the purposes of the present invention, compounds suitable as onium perchlorates are those which on the N, S or P atom bear at least one organic moiety and at most the maximum possible number of organic moieties. If an onium perchlorate suitable for the invention bears fewer organic moieties than needed to generate a positively charged onium ion, the positive charge is generated in a conventional manner known to the person skilled in the art, by way of example via protonation by means of a suitable acid, and the corresponding onium perchlorate therefore bears at least one proton alongside an organic moiety in this case.

Compounds suitable as onium perchlorates in the invention are therefore those which have a positive charge based on protonation reactions. However, it is equally possible for the purposes of the inventive salt preparations or stabilizer compositions to use onium perchlorates which have a positive charge based on an alkylation reaction or peralkylation reaction. Examples of these compounds are tetraalkylammonium perchlorates, trialkylsulfonium perchlorates or tetraalkylphosphonium perchlorates. However, the present invention equally provides that an onium perchlorate suitable for the invention has an aryl moiety, alkaryl moiety, cycloalkyl moiety, alkenyl moiety, alkynyl moiety or cycloalkenyl moiety. The invention also allows and provides that an onium salt which can be used for the purposes of an inventive salt preparation has two or, if appropriate, more than two different substituent types, for example an alkyl moiety and a cycloalkyl moiety or an alkyl moiety and an aryl moiety.

The present invention also allows and provides that an onium salt which can be used for the purposes of an inventive salt preparation has substituents which themselves have one or more substituent functional groups. The “functional groups” here means groups which improve the actions of the salt preparation or stabilizer composition or at least do not, or do not substantially, impair these actions. Examples of appropriate functional groups can be NH groups, NH₂ groups, OH groups, SH groups, ester groups, ether groups, thioether groups, isocyanurate groups or ketone groups or a mixture composed of two or more of these.

For the purposes of the present invention, it is possible in principle to use, as phosphonium perchlorates, any of the compounds which lead to a phosphonium perchlorate by virtue of appropriate reaction of suitable reactants. Phosphonium perchlorates which can be used in the invention here can, for example, be obtained via appropriate reaction of tetralkylphosphorus halides, tetracycloalkylphosphorus halides or tetraarylphosphorus halides. Suitable phosphonium perchlorates are therefore derived by way of example from tetraalkylphosphorus salts such as tetra-n-ethylphosphonium bromide, tetra-n-propylphosphonium bromide, tetra-n-butylphosphonium bromide, tetra-n-isobutylphosphonium bromide tetra-n-pentylphosphonium bromide, tetra-n-hexylphosphonium bromide and similar tetraalkylphosphorus salts.

Other compounds suitable in principle for use for the purposes of the present salt preparations are phosphonium perchlorates which derive, for example, from tetracycloalkylphosphorus salts or from tetraarylphosphorus salts. Suitable phosphonium perchlorates are therefore based, for example, on tetracycloalkylphosphorus salts or tetraarylphosphorus salts, such as tetracyclohexylphosphonium bromide or tetraphenylphosphonium bromide and similar tetracycloalkylphosphorus salts or tetraarylphosphorus salts. For the purposes of the present invention, the abovementioned compounds can be unsubstituted, but they can also have one or more of the above-mentioned substituents, as long as these substituents do not have any disadvantageous actions for the purposes of the salt preparation or stabilizer composition and do not adversely affect the intended use of the salt preparation.

For the purposes of the present invention, it is equally possible to use organic phosphonium perchlorates which bear different types of organic substituents on a phosphorus atom, and these substituents can in turn, if appropriate, have various substitution.

For the purposes of one preferred embodiment of the present invention, the phosphonium perchlorates used comprise tetra-n-butylphosphonium perchlorate or triphenylbenzylphosphonium perchlorate.

For the purposes of the present invention, it is possible in principle to use, as sulfonium perchlorates, any of the compounds which lead to a sulfonium perchlorate by virtue of appropriate reaction of suitable reactants. Sulfonium perchlorates which can be used in the invention here can, for example, be obtained via appropriate reaction of sulfides such as alkyl monosulfides, alkyl disulfides, dialkyl sulfides or polyalkyl sulfides. Suitable sulfonium perchlorates therefore derive by, for example, from dialkyl sulfides such as ethyl benzyl sulfide or allyl benzyl sulfide or from alkyl disulfides such as hexane disulfide, heptane disulfide or octane disulfide and similar alkyl disulfides.

Other compounds suitable in principle for use for the purposes of the present salt preparations are sulfonium perchlorates which derive, for example, from tricycloalkylphosphorus salts or from triarylphosphorus salts. Suitable sulfonium perchlorates are therefore based, for example, on tricycloalkylsulfonium salts or triarylsulfonium salts, such as tricyclohexylsulfonium bromide or triphenylsulfonium bromide and similar tricycloalkylsulfonium salts or triarylsulfonium salts. Trialkylsulfoxonium salts, triarylsulfoxonium salts or tricycloalkylsulfoxonium salts are equally suitable, an example being trimethylsulfoxonium perchlorate. For the purposes of the present invention, the abovementioned compounds can be unsubstituted, but they can also have one or more of the abovementioned substituents, as long as these substituents do not have any disadvantageous actions for the purposes of the salt preparation or stabilizer composition and do not adversely affect the intended use of the salt preparation.

For the purposes of the present invention it is equally possible to use organic sulfoniums perchlorates which bear different types of organic subsituents on a sulfur atom, and these can in turn, if appropriate, have various substitutions.

For the purposes of one preferred embodiment of the present invention, the sulfonium perchlorate used comprises trimethylsulfoxonium perchlorate.

For the purposes of the present invention, it is possible in principle to use, as ammonium perchlorates, any of the compounds which lead to a ammonium perchlorate by virtue of appropriate reaction of suitable reactants. Ammonium perchlorates which can be used in the invention here can, for example, be obtained via appropriate reaction of amines or amides, such as alkylmonoamines, alkylenediamines, alkylpolyamines, or secondary or tertiary amines. Suitable ammonium perchlorates therefore derive, for example, from primary mono- or polyamino compounds having from 2 to about 40 carbon atoms, for example from 6 to about 20 carbon atoms. Examples of these are ethylamine, n-propylamine, isopropylamine, n-butylamine sec-butylamine, tert-butylamine, and substituted amines having from 2 to about 20 carbon atoms, such as 2-(N,N-dimethylamino)-1-aminoethane. Suitable diamines have, for example, two primary, two secondary or two tertiary, or one primary and one secondary or one primary and one tertiary, or one secondary and one tertiary amino group. Examples of these compounds are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophorone diamine, IPDA), 4,4′-diaminodicyclohexylmethane, 1,4-diaminocyclohexane, aminoethyl-ethanolamine, hydrazine, hydrazine hydrate, or triamines, such as diethylenetriamine or 1,8-diamino-4-aminomethyloctane, or tertiary amines, such as triethylamine, tributylamine, dimethylbenzylamine, N-ethylmorpholine, N-methylmorpholine, N-cyclohexylmorpholine, dimethylcyclohexylamine, dimorpholinediethyl ether, 1,4-diazabicyclo[2.2.2]octane, 1-azabicyclo[3.3.0]-octane, N,N,N′,N′-tetramethyl-ethylenediamine, N,N,N′,N′-tetramethyl-butanediamine, N,N,N′,N′-tetramethylhexane-1,6-diamine, pentamethyldiethyl-enetriamine, tetramethyl-diaminoethyl ether, bis(dimethylaminopropyl)urea, N,N′-dimethylpiperazine, 1,2-dimethylimidazole or di(4-N,N-dimethyl-aminocyclohexyl)methane.

Aliphatic amino alcohols having from 2 to about 40 carbon atoms, preferably from 2 to about 20 carbon atoms, are equally suitable, examples being ethanolamine, diethanolamine, triethanolamine, tripropanolamine, tributanolamine, tripentanolamine, 1-amino-3,3-dimethylpentan-5-ol, 2-aminohexane-2′,2″-diethanolamine, 1-amino-2,5-dimethylcyclohexane-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethyl-aminoethoxy)ethanol, aromatic-aliphatic or aromatic-cycloaliphatic amino alcohols having from 6 to about 20 carbon atoms, where heterocyclic or isocyclic ring systems are used as aromatic structures, examples being naphthalene derivatives or in particular benzene derivatives, such as 2-aminobenzyl alcohol, 3-(hydroxymethyl)aniline, 2-amino-3-phenyl-1-propanol, 2-amino-1-phenyl-ethanol, 2-phenylglycinol or 2-amino-1-phenyl-1,3-propanediol, and also mixtures composed of two or more of these compounds.

For the purposes of another embodiment of the present invention, the ammonium perchlorates used comprise the perchlorates of heterocyclic compounds which have a ring system having amino groups.

An inventive salt preparation can, for example, comprise only one salt of a halogen-containing oxy acid. However, the present invention equally allows and provides that an inventive salt preparation comprises a mixture composed of two or more salts of halogen-containing oxy acids.

For the purposes of one preferred embodiment of the present invention, an inventive salt preparation comprises sodium perchlorate, for example.

The proportion of the salt of a halogen-containing oxy acid or of a mixture composed of two or more halogen-containing oxy acids in the inventive salt preparation is from about 0.01 to about 99.99% by weight, for example from about 0.1 to about 90% by weight or from 1 to about 85% by weight, for example from about 5 to about 80% by weight or from about 10 to about 70% by weight. Other suitable amounts are approximately in the range from about 15 to about 65% by weight or from about 20 to about 60% by weight, based in each case on the entire salt preparation.

An inventive salt preparation comprises, as a second constituent, at least one solvent. For the purposes of the present invention, a “solvent” is a compound which can dissolve a salt of a halogen-containing oxy acid or a mixture composed of two or more salts of halogen-containing oxy acids.

An inventive salt preparation can, for example, comprise only one solvent. However, the present invention equally allows and provides that an inventive salt preparation comprises a mixture composed of two or more solvents.

The proportion of a solvent or of a mixture composed of two or more solvents in the inventive salt preparation is, for example, from about 0.01 to about 99.9% by weight, based in each case on the entire salt preparation, the balance of 100% by weight being substantially provided by the salt of a halogen-containing oxy acid or by the mixture composed of two or more of the salts in the salt preparation.

For the purposes of the present invention, a salt of a halogen-containing oxy acid or a mixture of two or more salts of halogen-containing oxy acid is “soluble” in a solvent or in a mixture composed of two or more solvents, to the extent that the amount that dissolves at 20° C. is at least 0.1% by weight thereof or at least 0.5% by weight thereof or at least 1.0% by weight thereof, or at least 3.0% by weight thereof or at least 5.0% by weight thereof or at least 10% by weight thereof or at least 15% by weight thereof or at least 20% by weight thereof, in each case based on the solvent or the mixture composed of two or more solvents. In particular cases, the solubility is, for example, at least about 40% by weight or at least about 60% by weight or at least 80% by weight or indeed is even higher, for example at least about 100% by weight or at least about 120% by weight, in each case on the solvent or the mixture composed of two or more solvents.

An inventive salt preparation here can, for example, be composed exclusively of a solution, i.e. of a mixture with dispersion is substantially at the molecular level and which is composed of salts of halogen-containing oxy acids and solvent. However, it is equally possible that an inventive salt preparation comprises substantially any desired amounts of undissolved salt constituents, for example up to about 90% by weight or less of undissolved salts of halogen-containing oxy acids, for example up to about 80, 70, 60, 50, 40, 30, 20, 10 or 5% by weight or less, based in each case on the entire salt preparation. For the purposes of another embodiment of the present invention, an inventive salt preparation comprises less than about 30% by weight, in particular less than about 10% by weight, or less than about 5% by weight, of undissolved salts of halogen-containing oxy acids, based in each case on the entire salt preparation.

The mixing ratio between a salt of a halogen-containing oxy acid or a mixture composed of two or more salts of halogen-containing oxy acids and a solvent or the mixture composed of two or more solvents in a mixture can be varied widely, with the proviso that the salt preparation is solid at a temperature of 80° C. or, for example, at 60° C. or at 50° C. or at 40° C. or at 30° C. or at 20° C. or at 10° C. or at 5° C. or at 0° C. By way of example, the mixing ratio between a salt of a halogen-containing oxy acid or a mixture composed of two or more salts of halogen-containing oxy acid and a solvent or the mixture composed of two or more solvents in a mixture is from 1:100 to 100:1 or from 1:80 to 80:1 or from 1:60 to 60:1 or from 1:40 to 40:1 or from 1:20 to 20:1 or from 1:10 to 10:1 or from 5:1 to 1:5 or from 3:1 to 1:3, the ratios mentioned here being based on weight.

For the purposes of the present invention, “solid” describes the presence of a substance, for example of an inventive salt preparation, of a stabilizer composition, of a salt of a halogen-containing oxy acid or of a solvent, where the condition of the substance makes its shape independent of the container in which it is found. For the purposes of the present invention, the viscosity of a solid substance is, for example, 10⁶ mPa s or more than 10⁶ mPa s or more than 10⁷ mPa s or more than 10⁸ mPa s or more than 10⁹ mPa s or more than 10¹⁰ mPa s or more than 10¹¹ mPa s. For the purposes of the present invention, a solid substance can, for example, be cuttable.

For the purposes of the present invention, “liquid” means, in contrast, the presence of a substance, for example of an inventive salt preparation, of a stabilizer composition, of an organic onium salt of a halogen-containing oxy acid or of a solvent in a condition which makes its shape dependent on the container in which it is found. For the purposes of the present invention, the viscosity of a liquid substance is, for example, at least 0.2 mPa s and less than 10⁶ mPa s or less than 10³ mPa s or less than 10 mPa s or less than 1 mPa s or less than 0.5 mPa s.

For the purposes of another embodiment of the present invention, the mixing ratio between a salt of a halogen-containing oxy acid or a mixture composed of two or more salts of halogen-containing oxy acid and a solvent or the mixture composed of two or more solvents in a mixture is adjusted in such a way that the salt of a halogen-containing oxy acid or the mixture composed of two or more salts of halogen-containing oxy acids dissolves in the solvent or in the mixture composed of two or more solvents and at 80° C. or at 60° C. or at 50° C. or at 40° C. or at 30° C. or at 20° C. or at 10° C. or at 5° C. or at 0° C. forms a solid.

A salt of a halogen-containing oxy acid or a mixture composed of two or more salts of halogen-containing oxy acids can be present in an inventive salt preparation in substantially any desired manner, and the same applies to a solvent or a mixture composed of two or more solvents. A solvent or a mixture composed of two or more solvents can, for example, simply dissolve a salt of a halogen-containing oxy acid or a mixture composed of two or more salts of halogen-containing oxy acids. However, a solvent or a mixture composed of two or more solvents can also, for example, complex or chilate a salt of a halogen-containing oxy acid or a mixture composed of two or more salts of halogen-containing oxy acids.

A salt of a halogen-containing oxy acid or a mixture composed of two or more salts of halogen-containing oxy acids, for example, have been simply dissolved by a solvent or a mixture composed of two or more solvents. The salt of a halogen-containing oxy acid or the mixture composed of two or more salts of halogen-containing oxy acid and the solvent or the mixture composed of two or more solvents can be present here in a form in which these are substantially dispersed in one another at the molecular level. The interactions between a salt of a halogen-containing oxy acid or a mixture composed of two or more salts of halogen-containing oxy acids and a solvent or a mixture composed of two or more solvents can be relatively weak in this type of case, but are at least sufficient to ensure the presence of, or production of, a solution with dispersion at the molecular level at the desired temperature.

A salt preparation of the present invention can moreover comprise solvent molecules complexing salts of halogen-containing oxy acids. A salt preparation of the present invention therefore encompasses, for example, mixtures in which molecules of inventive solvents complex of the cations or the anions or the cations and the anions of the salts of halogen-containing oxy acids.

For the purposes of another embodiment of the invention, the present text therefore also relates to a salt preparation which comprises solvent molecules complexing at least one salt of a halogen-containing oxy acid, where solvent molecules complex at least one cation or at least one anion or at least one cation and at least one anion of one or more salts of halogen-containing oxy acids.

For the purposes of the present invention, these ions can be called complex cations or complex anions.

A salt preparation of the present invention encompasses, for example, solid mixtures comprising complexes composed of a salt of a halogen-containing oxy acid or of a mixture of two or more salts of halogen-containing oxy acids and of a solvent or of the mixture composed of two or more solvents.

A salt preparation corresponding to the present invention encompasses, for example, solid mixtures comprising at least one complex composed of a salt of a halogen-containing oxy acid and of a solvent or comprising at least one complex composed of two or more salts of halogen-containing oxy acid and of two or more solvents or at least one complex composed of two or more salts of halogen-containing oxy acids and of two or more solvents.

Inventive salt preparations here can comprise these complexes in amorphous or crystalline form or in amorphous and crystalline form.

A salt preparation of the present invention can moreover comprise solvent molecules chelating salts of halogen-containing oxy acids. A salt preparation according to the present invention encompasses, for example, solid mixtures where the solvent molecules of inventively suitable solvents have coordinated bonding to ions of a salt of a halogen-containing oxy acid or of a mixture composed of two or more salts of halogen-containing oxy acids, or, for example, have bonding by way of hydrogen bonds to these ions. Coordinatively bonded solvent molecules of the present invention generally have only relatively weak bonding to the inventive salts of halogen-containing oxy acids, when comparison is made with complexed solvent molecules of the present invention. Coordinatively bonded solvent molecules can, for example, often be removed by thermal treatment from a solid mixture of the present invention.

In the present invention, suitable solvents for the purposes of the mixture are either inorganic or organic solvents, and also mixtures of these. For the purposes of one preferred embodiment, organic solvents are used.

The present invention therefore also provides a salt preparation characterized in that the salt preparation comprises at least one organic solvent.

Suitable solvents for the invention are in particular polar organic solvents. Polar organic solvents suitable for the invention are any of the solvents whose molecules have an electrical dipolmoment. Polar organic solvents having electronegative heteroatoms, such as O, S, N, P, F, Cl, Br are particularly suitable.

Another embodiment of the present invention provides a salt preparation, characterized in that the salt preparation comprises at least one polar organic solvent.

Examples of polar organic solvents that can be used are polyols. For the purposes of the present invention, the term “polyols” denotes organic compounds which have two ore more OH groups per molecule. Examples of suitable polyols are pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, Lycasin, mannitol, lactose, leucrose, tri(hydroxyethyl) isocyanurate, palatinitol, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

For the purposes of another embodiment of the present invention, a salt preparation therefore encompasses at least one polyol as solvent.

Aliphatic amino alcohols are equally suitable as polar organic solvent, examples being amino monoalcohols or amino polyols having from 2 to about 40 carbon atoms, preferably from 2 to about 20 carbon atoms, are equally suitable, examples being ethanolamine, diethanolamine, triethanolamine, tripropanolamine, tributanolamine, tripentanolamine, 1-amino-3,3-dimethylpentan-5-ol, 2-aminohexane-2′,2″-diethanolamine, 1-amino-2,5-dimethylcyclohexane-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, aromatic-aliphatic or aromatic-cycloaliphatic amino alcohols having from 6 to about 20 carbon atoms, where heterocyclic or isocyclic ring systems are used as aromatic structures, examples being naphthalene derivatives or in particular benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures composed of two or more of these compounds.

The inventive method for the mixing of a salt of a halogen-containing oxy acid or of a mixture composed of two or more salts of halogen-containing oxy acids and of a solvent or of a mixture composed of two or more solvents consisting using the solvent during the mixing process in liquid form.

For the purposes of one preferred embodiment of the present invention, at least one solvent which exerts an advantageous effect on the stabilization of halogen-containing polymers is used as constituent of the inventive salt preparation.

The production of a solid salt preparation in the present invention is in principle successful with any of the methods known to the person skilled in the art for the mixing of different solid and liquid substances, for example via simple mixing of the salt of a halogen-containing oxy acid or of a mixture composed of two or more salts of halogen-containing oxy acids and of the solvent or of the mixture composed of two or more solvents. By way of example, the solvent or the mixture composed of two or more solvents can be used as initial charge, and the salt of a halogen-containing oxy acid of the mixture composed of two or more salts of halogen-containing oxy acids can be added. However, the invention also provides that the salt of halogen-containing oxy acid or the mixtures composed of two or more salts of halogen-containing oxy acids can be used as initial charge, the solvent or the mixture composed of two or more solvents then being added. A factor to be taken into account, if appropriate, in the selection of a method for the mixing of the components for the purposes of production of an inventive salt preparation is pronounced heat generation during the mixing process.

The present invention therefore also provides a salt preparation which can be produced via the mixing of a salt of a halogen-containing oxy acid or of a mixture composed of two or more salts of halogen-containing oxy acids with a solvent or with a mixture composed of two or more solvents, where at least 0.1% by weight of the salt of a halogen-containing oxy acid or of the mixture composed of two or more salts of halogen-containing oxy acids, based on the solvent or the mixture composed of two or more solvents, is dissolved in this and the salt preparation becomes solid at 5° C.

The invention therefore also provides processes for the production of a salt preparation which is solid at 5° C., characterized in that, by virtue of the mixing of a salt of a halogen-containing oxy acid or of a mixture composed of two or more salts of halogen-containing oxy acids with a solvent or with a mixture composed of two or more solvents, at least 0.1% by weight of the salt of a halogen-containing oxy acid or of the mixture composed of two or more salts of halogen-containing oxy acids, based on the solvent or the mixture composed of two or more solvents, is dissolved.

Another embodiment of the present invention provides a process in which the salt of a halogen-containing oxy acid or the mixture composed of two or more salts of halogen-containing oxy acid is, by virtue of mixing with a liquid solvent or with a mixture composed of two or more liquid solvents, dissolved to an extent of at least 0.1% by weight, based on the solvent or the mixture composed of two or more solvents, and by virtue of this the salt preparation becomes solid.

Solvents suitable for the production of inventive salt preparations are not only those which are liquid at room temperature. The invention equally provides the use of solvents which, for example, are solid at 80° C. or at 60° C. or at 50° C. or at 40° C. or at 30° C. or at least at room temperature.

To provide a liquid form of a solvent which is solid at room temperature or of a mixture composed of two or more solvents which are solid at room temperature, this can be heated at least during the time of the mixing process to a temperature suitable for the production of the inventive salt preparation, or can be kept within a suitable temperature range. By way of example, the solvent or the mixture composed of two or more solvents can be used in an initial charge and heated, and the salt of a halogen-containing oxy acid or the mixture composed of two or more salts of halogen-containing oxy acids can then be added. However, the invention also provides that the solvent or the mixture composed of two or more solvents and the salt of a halogen-containing oxy acid or of the mixture composed of two or more salts of halogen-containing oxy acids are used as initial charge, both being heated to a suitable temperature for the production of an inventive salt preparation. “A suitable temperature” in the invention means a temperature at which the mixing of a salt of a halogen-containing oxy acid or of a mixture composed of two or more salts of halogen-containing oxy acids and of the solvent or of the mixture composed of two or more solvents ensures the production of an inventive salt preparation.

The mixing of a salt of a halogen-containing oxy acid or of a mixture composed of two or more salts of halogen-containing oxy acid with a solvent or with a mixture composed of two or more solvents can therefore be achieved at various temperatures, with the proviso that the solvent or the mixture composed of two or more solvents is present in liquid form.

The mixing process can therefore, for example, be achieved at room temperature, but the invention equally provides that the mixing is also achieved at temperatures below or above room temperature. In principle, the temperature during the mixing process should be selected in such a way that the solution procedure during the mixing process is achieved with maximum speed, but no, or at least no substantial, reaction can take place between the salt of a halogen-containing oxy acid or the mixture composed of two or more salts of halogen-containing oxy acids and the solvent or the mixture composed of two or more solvents. The mixing process can therefore in principle be achieved in the temperature range from −50° C. to 200° C. For the purposes of other embodiments of the present invention, the mixing process can take place in the temperature range form −30° C. to 180° C. or of −10° C. to 160° C. or of 10° C. to 140° C. or of 20° C. to 130° C. or of 20° C. to 110° C. or of 20° C. to 90° C. or of 20° C. to 70° C. or of 20° C. to 50° C.

The present invention therefore also provides the process for the production of a salt preparation, characterized in that
a) the solvent or the mixture composed of two or more solvents is melted by heating,
b) the salt of a halogen-containing oxy acid or the mixture composed of two or more salts of halogen-containing oxy acids is, by virtue of mixing with the solvent or with the mixture composed of two or more solvents, dissolved in this to an extent of at least 0.1% by weight, based on the solvent or the mixture composed of two or more solvents,
c) and the resultant salt preparation is cooled,
   and by virtue of this the salt preparation becomes solid.

A salt preparation of the present invention can, for example, be used as a stabilizer composition or as constituent of a stabilizer composition for the stabilization of halogen-containing polymers.

For the process of the present invention, a “stabilizer composition” is a stabilizer composition which can be used for the stabilization of halogen-containing polymers. To achieve this stabilizing effect, an inventive stabilizer composition is generally mixed with a halogen-containing polymer intended for stabilization and then processed. However, it is equally possible to admix, during processing, the inventive step of either composition with the halogen-containing polymers to be stabilized.

A salt composition of the present invention can simply be used alone, i.e. without addition of further additives, as a stabilizer composition for the stabilization of halogen-containing polymers. However, it is often advantageous to mix an inventive salt preparation with further additives to give a stabilizer composition.

Examples of suitable additives include amino alcohols, to be extent that they are not by this stage present as solvent in the inventive salt preparation. For the purposes of the present invention, suitable amino alcohols are in principle any of the compounds which have at least one OH group and one primary, secondary or tertiary amino group or a combination composed of two or more of the amino groups mentioned. For the purposes of the present invention, either solid or liquid amino alcohols are in principle suitable as constituent of the inventive stabilizer compositions. For the purposes of the present invention, however, the proportion of liquid amino alcohols is, for example, selected in such a way that the entire stabilizer composition is substantially in solid form.

Examples of suitable compounds are compounds bearing OH groups and derived from primary mono- or polyamino compounds having from 2 to about 40 carbon atoms, for example from 6 to about 20 carbon atoms. By way of example, these are appropriate compounds of bearing OH groups and derived from ethylamine, from n-propylamine, i-propylamine, from sec-propylamine, from tert-butylamine, from 1-aminoisobutane, or from substituted amines having from 2 to about 20 carbon atoms, e.g. 2-(N,N-dimethylamino)-1-aminoethane. Examples of suitable compounds bearing OH groups and derived from diamines are those based on diamines whose molar mass is from about 32 to about 200 g/mol, where the corresponding diamines have at least two primary or two secondary or one primary and one secondary amino group(s). Examples here are diaminoethane, the isomeric diaminopropanes, the isomeric diaminobutanes, the isomeric diaminohexanes, piperazine, 2,5-dimethylpiperazine, amino-3-aminomethyl-3,5,5-trimethyl-cyclohexane (isophorone diamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethylmorpholine, N-methyl-morpholine, N-cyclohexylmorpholine, dimethylcyclohexylamine, dimorpholinediethyl ether, 1,4-diazabicyclo[2.2.2]octane, 1-azabicyclo[3.3.0]-octane, N,N,N′,N′-tetramethylethylenediamine, N,N,N′,N′-tetramethyl-butanediamine,N,N,N′,N′-tetramethylhexane-1,6-diamine, pentamethyl-diethylenetriamine, tetramethyldiaminoethyl ether, bis(dimethylaminopropyl)urea, N,N′-dimethylpiperazine, 1,2-dimethylimidazole or di(4-N,N-dimethyl-aminocyclohexyl)methane.

Aliphatic amino alcohols having from 2 to about 40 carbon atoms, preferably from 6 to about 20 carbon atoms, can be particularly suitable, examples being 1-amino-3,3-dimethylpentan-5-ol, 2-aminohexane-2′,2″-diethanolamine, 1-amino-2,5-dimethylcyclohexane-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, aromatic-aliphatic or aromatic-cycloaliphatic amino alcohols having from 6 to about 20 carbon atoms, where heterocyclic or isocyclic ring systems are used as aromatic structures, examples being naphthalene derivatives or in particular benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures composed of two or more of these compounds.

For the purposes of one particularly preferred embodiment of the present invention, the amino alcohols used comprise heterocyclic compounds which have a ring system having amino groups, where the OH groups either have direct bonding to the ring or preferably have bonding thereto by way of spacers.

For the purposes of one particularly preferred embodiment of the present invention, use is made here of heterocyclic amino alcohols which have at least 2, preferably at least 3, amino groups in the ring. A particularly suitable central ring constituent of the amino alcohols which can be used in the invention is provided here by the trimerization products of isocyanates.

Isocyanurates of the general formula I containing hydroxyl groups are particularly preferred here

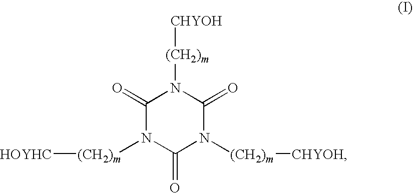

in which the groups Y and the indices m are in each case identical or different and m is a whole number from 0 to 20 and Y is a hydrogen atom or a linear or branched, saturated or unsaturated alkyl group having from 1 to about 10 carbon atoms. For the purposes of the present invention, particular preference is given to these tris(hydroxyethyl) isocyanurate (THEIC) as constituent of the inventive stabilizer compositions.

An inventive stabilizer composition can, for example, comprise only one amino alcohol. However, the present invention equally provides that an inventive stabilizer composition comprises a mixture composed of two or more different amino alcohols.

Equally suitable additives for the purposes of the present invention are compounds having a structural element of the general formula II

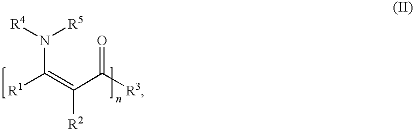

in which n is a number from 1 to 100,000, the moieties R⁴, R⁵, R¹ and R², each independently of the others, are hydrogen, or an unsubstituted or substituted linear or branched, saturated or unsaturated aliphatic alkyl moiety having from 1 to 44 carbon atoms, or an unsubstituted or substituted saturated or unsaturated cycloalkyl moiety having from 6 to 44 carbon atoms, or an unsubstituted or substituted aryl moiety having from 6 to 44 carbon atoms, or an unsubstituted or substituted aralkyl moiety having from 7 to 44 carbon atoms, or the moiety R¹ is an unsubstituted or substituted acyl moiety having from 2 to 44 carbon atoms, or the moieties R¹ and R² have bonding to give an aromatic or heterocyclic system, and in which the moiety R³ is hydrogen, an unsubstituted or substituted, linear or branched, saturated or unsaturated aliphatic alkyl or, respectively, alkylene moiety or, respectively, oxyalkyl or oxyalkylene moiety, or, mercaptoalkyl or mercaptoalkylene moiety or, respectively, aminoalkyl or aminoalkylene moiety, having from 1 to 44 carbon atoms, an unsubstituted or substituted saturated or unsaturated cycloalkyl or cycloalkylene moiety or, respectively, oxycycloalkyl or oxycycloalkylene moiety or, respectively, mercaptocycloalkyl or mercaptocycloalkylene moiety or, respectively, aminocycloalkyl or aminocycloalkylene moiety, having from 6 to 44 carbon atoms, or an unsubstituted or substituted aryl or arylene moiety having from 6 to 44 carbon atoms, or an ether or thioether moiety having from 1 to 20 O atoms or, respectively, S atoms, or, respectively, O and S atoms, or a polymer has bonding by way of O, S, NH, NR⁴ or CH₂C(O) to the structural element placed within, or the moiety R³ has bonding to the moiety R¹ in such a way as to form, in total, an unsubstituted or substituted, saturated or unsaturated heterocyclic ring system having from 4 to 24 carbon atoms, or a mixture composed of two or more compounds of the general formula I.

For the purposes of one preferred embodiment of the present invention, a compound based on an α,β-unsaturated β-aminocarboxylic acid, in particular a compound based on β-aminocrotonic acid, is used as compound of the general formula I. Particularly suitable compounds here are the esters or thioesters of the corresponding aminocarboxylic acids with hydrate or polyhydrate alcohols or mercaptans, where X in the cases mentioned is respective O or S.

If the moiety R³ together with X is an alcohol moiety of mercapto moiety, this moiety can, for example, be formed from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thiodiethanol, trimethylolpropane, glycerol, tris(2-hydroxyethyl) isocyanurate, triethanolamine, pentaerythritol, ditrimethylolpropane, diglycerol, sorbitol, mannitol, xylitol, dipentaerythritol, or else from the corresponding mercapto derivatives of the alcohols mentioned.

For the purposes of one particularly preferred embodiment of the present invention, the compound used of the general formula II comprises a compound in which R¹ is a linear alkyl moiety having from 1 to 4 carbon atoms, R² is hydrogen and R³ is a linear or branched, saturated, mono- to hexavalent alkyl or alkylene moiety having from 2 to 12 carbon atoms or a linear, branched or cyclic di- to hexavalent ether alcohol moiety or thioether alcohol moiety.

Suitable compounds of the general formula II are encompassed, for example, β-aminocrotonate, 1,4-butanediol di(β-aminocrotonate), thiodiethanol β-aminocrotonate, trimethylolpropane tri-β-aminocrotonate, pentaerythritol tetra-β-aminocrotonate, dipentaerythritol hexa-β-aminocrotonate and the like. The compounds mentioned can in each case by present alone or as a mixture composed of two or more thereof in an inventive stabilizer composition.

For the purposes of the present invention, aminoouracil compounds of the general formula III are equally suitable as compounds of the general formula II

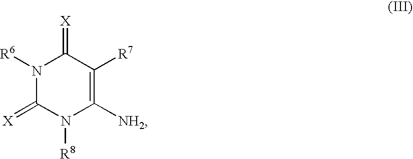

in which the moieties R⁶ and R⁷, each independently of the others, are hydrogen, or an unsubstituted or substituted linear or branched, saturated or unsaturated aliphatic alkyl moiety having from 1 to 44 carbon atoms, or an unsubstituted or substituted saturated or unsaturated cycloalkyl moiety having from 6 to 44 carbon atoms, or an unsubstituted or substituted aryl moiety having from 6 to 44 carbon atoms, or an unsubstituted or substituted aralkyl moiety having from 7 to 44 carbon atoms, or the moiety R⁶ is an unsubstituted or substituted acyl moiety having from 2 to 44 carbon atoms, or the moieties R⁶ and R⁷ have bonding to give an aromatic or heterocyclic system, and in which the moiety R⁸ is hydrogen, an unsubstituted or substituted, linear or branched, saturated or hydrocarbon moiety having from 1 to 44 carbon atoms, an unsubstituted or substituted saturated or unsaturated cycloaliphatic hydrocarbon radical having from 6 to 44 carbon atoms, or an unsubstituted or substituted aromatic hydrocarbon radical having from 6 to 44 carbon atoms, and X is S or O.

The compound of formula III is therefore one of the compounds of formula I, where n in the general formula I is 1 and the moieties R¹ and R³ of the general formula I have bonding to the structural element of the general formula IV

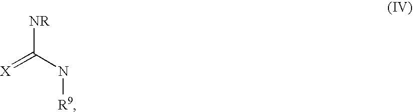

in which X is S or O. R¹ therefore being N—R⁹ in the case of a compound of the general formula IV, while R³ is —RN—C═X and both moieties have covalent linkage related to a heterocyclic ring, by way of a N—C bond.

For the purposes of the present invention, it is preferable to use compounds of the general formula IV in which R⁹ is hydrogen.

For the purposes of another preferred embodiment of the present invention, the inventive stabilizer compositions use compounds of the general formula III in which R⁶ and R⁸ are a linear or branched alkyl moiety having from 1 to 6 carbon atoms, e.g. methyl, ethyl, propyl, butyl, pentyl or hexyl, a linear or branched alkyl moiety having from 1 to 6 carbon atoms and substituted with OH groups, e.g. hydroxymethyl, hydroxyethyl, hydroxypropyl, hydroxybutyl, hydroxypentyl or hydroxyhexyl, an aralkyl moiety having from 7 to 9 carbon atoms, e.g. benzyl, phenylethyl, phenylpropyl, dimethylbenzyl or phenylisopropyl, where the aralkyl moieties mentioned can, for example, have substituted by halogen, hydroxyl or methoxy, or an alkenyl moiety having from 3 to 6 carbon atoms, e.g. vinyl, alkyl, methallyl, 1-butenyl or 1-hexenyl.

For the purposes of one preferred embodiment of the present invention, the inventive stabilizer compositions whose compounds of the general formula III, in which R⁶ and R⁸ are hydrogen, methyl, ethyl, n-propyl, isopropyl, n-butyl, isobutyl, sec-butyl or tert-butyl.

Examples of compounds equally suitable as compounds of the general formula I are those in which the moieties R¹ and R² have bonding to an aromatic or heteroaromatic system, examples being aminobenzoic acid, aminosalicylic acid, or aminopyridinecarboxylic acid and suitable derivatives thereof.

For the purposes of one preferred embodiment of the present invention, an inventive stabilizer composition comprises a compound of from about 0.1 to about 99.5% by weight, in particular from about 5 to about 50% by weight or from about 5 to about 25% by weight, of a compound of the general formula I or a mixture comprising two or more compounds of the general formula I, for example a compound of the general formula III.

For the purposes of the present invention, examples of other suitable additives are those which have at least one mercapto-functional, sp²-hybridized carbon atoms. For the purposes of the present invention, compounds which have at least one mercapto-functional, sp²-hybridized carbon atom or in principle any of the compounds which have a Z¹═CZ²-SH or a structural element (Z¹H, Z²)C═S, or a structural element, where both structural elements can be tautomeric forms of a single compound. Z¹ and Z² designate substituted or unsubstituted organic radicals which in combination with the mercapto-functional, sp²-hybridized carbon atoms give inventive compounds which have at least one mercapto-functional, sp²-hybridized carbon atom. Z¹ and Z² here can, if appropriate, have bonding to one another and be part of a ring system. The sp²-hybridized carbon atom here can be a constituent of an unsubstituted or substituted aliphatic compound or a constituent of an aromatic system. Examples of suitable types of compound are thiocarbamic acid derivatives, thiocarbamates, thiocarboxylic acids, thiobenzoic acid derivatives, thioacetone derivatives, or thiourea, or thiourea derivatives. Suitable compounds having at least one mercapto-functional, sp 2-hybridized carbon atom are described by way of example in the German patent application with application number 101 09 366.7.

For the purposes of one preferred embodiment of the present invention, the compound used having at least one mercapto-functional, sp²-hybridized carbon atoms comprises thiourea or a thiourea derivative.

Examples of equally suitable additives for the inventive stabilizer compositions are carbazole or carbazole derivatives, or a mixture comprising two or more thereof.

Examples of other suitable additives are 2,4-pyrrolidinedione or its derivatives, such as those mentioned by way of example in the German patent application with application number 101 09 366.7, not published prior to the priority date of this application.

Examples of other suitable additives are epoxy compounds. Examples of these epoxy compounds are epoxidized soya oil, epoxidized olive oil, epoxidized linseed oil, epoxidized castor oil, epoxidized peanut oil, epoxidized maize oil, epoxidized cottonseed oil, and also glycidyl compounds.

Glycidyl compounds contain a glycidyl group directly bonded to a carbon atom, oxygen atom, nitrogen atom, or sulfur atom. Glycidyl esters or methylglycidyl esters are obtainable via reaction of a compound having at least one carboxy group in the molecule and epichlorohydrin or glycerol dichlorohydrin, or methylepichlorohydrin. The reaction advantageously takes place in the presence of bases.

Examples of compounds that can be used having at least one carboxy group in the molecule are aliphatic carboxylic acids. Examples of these acids are glutaric acid, adipic acid, pimelic acid, suberic acid, azeleic acid, sebacic acid, or dimerized or trimerized linoleic acid, acrylic acid, methacrylic acid, caproic acid, caprylic acid, lauric acid, myristic acid, palmitic acid, stearic acid, or pelargonic acid, and also the mono- or polycarboxylic acids mentioned in the further course of this text. Cycloaliphatic carboxylic acids are equally suitable, examples being cyclohexanecarboxylic acid, tetrahydrophthalic acid, 4-methyltetrahydrophthalic acid, hexahydrophthalic acid, endomethylenetetrahydrophthalic acid, or 4-methylhexahydrophthalic acid. Other suitable compounds are aromatic carboxylic acid, such as benzoic acid, phthalic acid, isophthalic acid, trimellitic acid, or pyromellitic acid.

Glycidyl ethers or methylglycidyl ethers can be obtained via reaction of the compound having at least one free alcoholic OH group or one phenolic OH group and a suitably substituted epichlorohydrin under alkaline conditions or in the presence of an acidic catalyst, and subsequent alkali treatment. Ethers of this type derive, for example, from acyclic alcohols, such as ethylene glycol, diethylene glycol, or higher poly(oxytetramethylene) glycols, propane-1,2-diol, or poly(oxypropylene) glycols, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythriol, or sorbitol, or else from polyepichlorohydrins, butanol, amyl alcohol, or pentanol, or else from monohydric alcohols, such as isooctanol, 2-ethylhexanol, or of isodecanol, or from technical alcohol mixtures, such as technical fatty alcohol mixtures.

Suitable ethers also derive from cycloaliphatic alcohols, such as 1,3- or 1,4-dihydroxycyclohexane, bis(4-hydroxycyclohexyl)methane, 2,2-bis(4-hydroxycyclohexyl)propane, or 1,1-bis(hydroxymethyl)cyclohex-3-ene, or have aromatic rings, an example being N,N-bis(2-hydroxyethyl)aniline. Suitable epoxy compounds can also derive from mononuclear phenol, for example from phenol, resorcinol, or hydroquinone, or are based on polynuclear phenols, such as bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulfones, or from phenol-formaldehyde condensates obtained under acidic conditions, e.g. phenol novolaks.

Other suitable epoxides for the purposes of the present invention are terminal epoxides such as glycidyl 1-naphthyl ether, glycidyl 2-phenylphenyl ether, 2-diphenyl glycidyl ether, N-(2,3-epoxypropyl)phthalimide or 2,3-epoxypropyl 4-methoxyphenyl ether.

N-glycidyl compounds are equally suitable, for example those obtainable via dehydrochlorination of the reaction products of any chlorohydrin with a means which contain at least one amino hydrogen atom. Examples of these amines are aniline, N-methylaniline, toluidine, n-butylamine, bis(4-aminophenyl)methane, m-xylylenediamine, or bis(4-methylaminophenyl)methane.

S-glycidyl compounds are equally suitable, examples being di-S-glycidyl ether derivatives which derive from dithiols, such as ethane-1,2-dithiol or bis(4-mercaptomethylphenyl)ether.

Particularly suitable epoxy compounds are described by way of example on pages 3 to 5 of EP-A 1 046 668, and the disclosure in that document is expressly incorporated herein by way of reference and is considered to be part of the disclosure of the present text.

Other suitable additives for the purposes of the present invention are 1,3-dicarbonyl compounds, in particular the P-diketones and P-ketoesters. For the purposes of the present invention, suitable dicarbonyl compounds are those of the general formula R′C(O)CHR″—C(O)R′″, examples of these being those described on page 5 of EP-1 046 668, which is expressly incorporated herein by way of reference, and the disclosure of which is considered to be part of the disclosure of the present text. Examples of particularly suitable compounds here are acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, 5-hydroxycarpronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane bis(4-methoxybenzoyl)methane, benzoylformylmethane, benzoylacetylphenylmethane, 1-benzoyl-1-acetylmethane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, the methyl, ethyl, butyl, 2-ethylhexyl, dodecyl, or octadecyl esters of diacetoacetic acid, and also propionyl- or butyrylacetics having from 1 to 18 carbon atoms, and also the ethyl, propyl, butyl, hexyl, or octyl ester of stearoylacetic acid, or polynuclear β-ketoesters as described in EP-A 433 230, these being expressly incorporated herein by way of reference, or dehydroacetic acid, and also its zinc, magnesium, or alkali metal salts, or the alkali metal, alkaline earth metal, or zinc chelates of the compounds mentioned, to the extent that these exist.

The amount 1,3-diketo compounds present in an inventive stabilizer composition can be up to about 20% by weight, for example up to about 10% by weight.

Polyols are other additives suitable for the purposes of the inventive stabilizer compositions. Examples of suitable polyols are pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxyethyl) isocyanurate, palatinitol, tetramethylolcyclohexanol, tetramethylolcyclopentanol, tetramethylolcycloheptanol, glycerol, diglycerol, polyglycerol, thiodiglycerol, or 1-0-α-D-glycopyranosyl-D-mannitol dihydrate.

The amount present of the polyols suitable as additives in an inventive stabilizer composition can be up to about 30% by weight, for example up to about 10% by weight.

Examples of equally suitable additives are sterically hindered amines such as those mentioned in pages 7 to 27 of EP-A 1 046 668. The sterically hindered amines disclosed in that document are expressly incorporated herein by way of reference, and the compounds mentioned in that document are regarded as part of the disclosure of the present text.

The amount present of the sterically hindered amines suitable as additives in an inventive stabilizer composition can be up to about 30% by weight, for example up to about 10% by weight.

Other suitable additives in the inventive stabilizer compositions are hydrotalcites, zeolites, and alkali metal aluminocarbonates. Suitable hydrotalcites, zeolites, and alkali metal aluminocarbonates are described by way of example on pages 27 to 29 of in EP-A 1 046 668, on pages 3, 5, and 7 of EP-A 256 872, on pages 2 and 3 of DE-C 41 06 411, or on pages 2 and 3 of DE-C 41 06 404. These publications are expressly incorporated herein by way of reference, and their disclosure in the cited passages is regarded as part of the disclosure of the present text.

The amounts present of the hydrotalcites, zeolites, and alkali metal aluminocarbonates suitable as additives in an inventive stabilizer composition can be up to about 50% by weight, for example up to about 30% by weight.

Examples of equally suitable additives for the purposes of the inventive stabilizer compositions are hydrocalumites of the general formula V

M²⁺₍₂₊ₓ₎Al³⁺_{(1+y)}(OH)_{(6+z)}A^{j-}ₐ[Bᵣ]^{rl}_{b}*m H₂O (V),

in which M is calcium, magnesium, or zinc, or a mixture composed of two or more thereof, A is a j-valent inorganic or organic acid anion, j is 1, 2, or 3, B is an inorganic or organic acid anion different from A, r is a whole number ≧1, and, to the extent that r>1, gives the degree of polymerization of the acid anion, and 1 is 1, 2, 3, or 4, and gives the valency of the acid anion, where if r=1, 1 is 2, 3 or 4, and if r>1, 1 gives the valency of the individual monomer units of the polyanion, and is 1, 2, 3, or 4, and rl gives the total valency of the polyanion, and the following rules apply to the parameters x, y, a, b, r, z, and j:
0≦x<0.6,
0≦y<0.4, where either x=0 or y=0,
0<a<0.8/r, and
z=1+2x+3y−ja−r/b.

For the purposes of one preferred embodiment of the present invention, compounds of the general formula V are used as additives, in which M is calcium, which, if appropriate, can be present in a mixture with magnesium or zinc or magnesium and zinc.

A in the general formula V is an r-valent inorganic or organic acid anion, where r is 1, 2, or 3. Examples of acid anions present in hydrocalumites that can be used according to the invention are halide ions, SO₃²⁻, SO₄²⁻, S₂O₃²⁻, S₂O₄²⁻, HPO₃²⁻, PO₄³⁻, CO₃²⁻, alkyl- and dialkyl phosphates, alkyl mercaptides, and alkylsulfonates, in which the alkyl groups can be identical or different, straight-chain, branched or cyclic, preferably having from 1 to about 20 carbon atoms. Equally suitable acid anions A are the anions of, if appropriate, functionalized, di-, tri-, or tetracarboxylic acids, e.g. maleate, phthalate, aconitate, trimesinate, pyromellitate, maleate, tartrate, citrate, and also anions of the isomeric forms of hydroxyphthalic acid or of hydroxymesic acid. For the purposes of one preferred embodiment of the present invention, A is an inorganic acid anion, in particular a halide ion, such as F⁻, Cl⁻, or Br⁻, preferably Cl⁻.

B in the general formula V is an acid anion different from A. If r is the number 1 in the general formula V, letter B is an 1-valent, inorganic or organic acid anion, where 1 is a number 2, 3, or 4. Examples of acid B present for the purposes of compounds of the general formula V that can be used according to the invention are O²⁻, SO₃²⁻, SO₄²⁻, S₂O₃²⁻, S₂O₄²⁻, HPO₃²⁻, PO₄³⁻, CO₃²⁻, alkyl- and dialkyl phosphates, alkyl mercaptides, and alkylsulfonates, in which the alkyl groups can be identical or different, straight-chain, branched or cyclic, preferably having from 1 to about 20 carbon atoms. Equally suitable acid anions A are the anions of, if appropriate, functionalized, di-, tri-, or tetracarboxylic acids, e.g. maleate, phthalate, aconitate, trimesinate, pyromellitate, maleate, tartrate, citrate, and also anions of the isomeric forms of hydroxyphthalic acid or of hydroxymesic acid. For the purposes of the present invention, B in the formula V is preferably a borate or an anion of an, if appropriate functionalized, di-, tri-, or tetracarboxylic acids. Particular preference is given here to carboxylic acid anions and anions of hydroxycarboxylic acids having at least two carboxy groups, and a particular preference is given here to citrates.

If r in the general formula V is a number greater than 1, the term [Bᵣ]^{rl-} is an inorganic or organic polyanion whose degree of polymerization is r and whose valency l of the individual monomer units of the polyanion is l, and whose total valency is rl, where l is greater than or equal to 1. Examples of suitable polyanions [Bᵣ]^{rl-} are polyacrylates, polycarboxylates, polyborates, polysilicates, polyphosphates, and polyphosphonates.

In all of the abovementioned cases, the acid anions A and B can be present in any desired a/b ratio in the compounds of the general formula V.

The compounds of the general formula V are not compounds of hydrotalcite type or of hydrocalumite type having a layer-like structure, but instead are a physical mixture of M²⁺/aluminum oxide hydrates with salts of divalent metals. X-ray diffraction patterns of the compounds used in the inventive step of either composition clearly show that these are not discrete crystalline compounds of a known type instead are amorphous mixtures as shown by X-ray analysis.

To prepare the compounds of the general formula V, known processes can be used, by mixing solutions or suspensions or of oxidic forms of the desired cations (e.g. NaAlO₂, Ca(OH)₂, Zn(OH)₂, Al(OH)₃) with solutions or suspensions of salts or the corresponding acids of the desired anions, and the mixture can be reacted at temperatures of from 40 to 95° C. The reaction times here can be varied from 15 to 300 minutes.

If a surface-treatment of the reaction products is desired, the surface-treatment agent can be admixed directly with the reaction products, and the product can be separated from the motherliquor via filtration and dried at suitable temperatures from 100 to 250° C. The amount of surface-treatment agent added is, for example, from about 1 to about 20% by weight.

For the purposes of the inventive stabilizer compositions, an amount of up to about 50% by weight, for example up to about 30% by weight or up to about 15% by weight, can be used of compounds of the general formula V.

For the purposes of another embodiment of the present invention, an inventive stabilizer composition comprises at least one basic calcium salt. Examples of suitable basic calcium salts are calcium oxide, calcium carbonate, or, to the extent that it is not by this stage a necessary constituent of the inventive stabilizer compositions, calcium hydroxide. The basic calcium salts can have been surface-modified, if appropriate.

The suitable additives of the inventive stabilizer compositions are metal oxides, metal hydroxides, and metal soaps of saturated, unsaturated, straight-chain or branched, aromatic, cycloaliphatic, or aliphatic carboxylic acids or hydroxycarboxylic acids preferably having from about 2 to about 22 carbon atoms.

The metal cations of the metal oxides, metal hydroxides, or metal soaps suitable as additives are preferably a divalent cation, and the cations of calcium or zinc or lead, or a mixture composed of two or more thereof, are particularly suitable, but for the purposes of one preferred embodiment of the present invention, the inventive stabilizer compositions are zinc-free.

Examples of suitable carboxylic acid anions encompass anions of monovalent carboxylic acids, such as acetic acid, propionic acid, butteric acid, valeric acid, hexanoic acid, enanthic acid, octanoic acid, neodecanoic acid, 2-ethylhexanoic acid, pelargoic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids and, respectively, of their monoesters, e.g. oxalic acid, malonic acid, maleic acid, tartaric acid, zimaric acid, mandelic acid, malic acid, glycolic acid, oxalic acid, salicylic acid, polyglycoldicarboxylic acids whose degree of polymerization is from about 10 to about 12, phthalic acid, isophthalic acid, terephthalic acid, or hydroxyphthalic acid, anions or tri- or tetravalent carboxylic acids and, respectively, of their mono-, di-, or triesters, e.g. hemimellitic acid, trimellitic acid, pyromellitic acid, or citric acid, and also “superbasic” carboxylates as described by way of example in DE-A 41 06 404 or in DE-A 40 02 988, and the disclosure of the last-mentioned documents is regarded here as part of the disclosure of the present text.

For the purposes of one preferred embodiment of the present invention, the additives used comprise metal soaps whose anions derived from saturated or unsaturated carboxylic acids or hydroxycarboxylic acids having from about 8 to about 20 carbon atoms. Particular preference is given here to stearates, oleates, laureates, palmitates, behenates, versatates, hydroxystearates, dihydroxystearates, p-tert-butylbenzoates, or (iso)octanoates of calcium or zinc, or a mixture composed of two or more thereof. For the purposes of another preferred embodiment of the present invention, an inventive stabilizer composition comprises calcium stearates or zinc stearates, or a mixture of these.

Embodiments of the present invention, and of inventive stabilizer composition comprises calcium stearate or zinc stearate, or a mixture of these.

The amount of the metal oxides, metal hydroxides, or metal soaps mentioned, or of a mixture composed of two or more thereof, in an inventive stabilizer composition can be up to about 50% by weight, for example up to about 30% by weight.

An inventive stabilizer composition can moreover comprise, as heat stabilizer component, an organotin compound or a mixture composed of two or more organotin compounds. Examples of suitable organotin compounds are methyltin tris(isooctyl thioglycolate), methyltin tris(isooctyl 3-mercaptopropionate), methyltin tris(isodecyl thioglycolate), dimethyltin bis(isooctyl thioglycolate), dibutyltin bis(isooctyl thioglycolate), monobutyltin tris(isooctyl thioglycolate), dioctyltin bis(isooctyl thioglycolate), monooctyltin tris(isooctyl thioglycolate) or dimethyltin bis(2-ethylhexyl-β-mercaptopropionate).

For the purposes of the inventive stabilizer compositions, it is also possible to use the organotin compounds which are mentioned, and whose preparation is described, on pages 18 to 29 of EP-A 0 742 259. The abovementioned disclosure is especially incorporated herein by way of reference, and the compounds mentioned therein and their preparation are regarded here as part of the disclosure of the present text.

The amount which can be present of the organotin compounds described in the inventive stabilizer composition is up to about 20% by weight, in particular up to about 10% by weight.

For the purposes of another embodiment of the present invention, an inventive stabilizer composition can comprise organic phosphite esters having from 1 to 3 organic moieties which are identical, or two of which are identical, or which are different. Examples of suitable organic moieties are linear or branched, saturated or unsaturated alkyl moieties having from 1 to 24 carbon atoms, unsubstituted or substituted alkyl moieties having from 6 to 20 carbon atoms, or unsubstituted or substituted aralkyl moieties having from 7 to 20 carbon atoms. Examples of suitable organic phosphite esters are tris(nonylphenyl), trilauryl, tributyl, trioctyl, tridecyl, tridodecyl, triphenyl, octyl diphenyl, dioctyl phenyl, tri(octylphenyl), tribenzyl, butyl dicresyl, octyl di(octylphenyl), tris(2-ethylhexyl), tritolyl, tris(2-cyclohexylphenyl), tri-α-naphthyl, tris(phenylphenyl), tris(2-phenylethyl), tris-(dimethylphenyl), tricresyl, or tris(p-nonylphenyl)phosphite, or tristearyl sorbitol triphosphite, or any mixture composed of two or more of these.

The amount present of the phosphite compounds described in an inventive stabilizer composition can be up to about 30% by weight, in particular up to about 10% by weight.

Peradditives that can be present in an inventive stabilizer composition are the capped mercaptans described on pages 4 to 18 of EP-A 0 742 259. The disclosure in the specification cited is expressly incorporated herein by reference, and is regarded as part of the disclosure of the present text.

The amount present of the capped mercaptan described in an inventive stabilizer composition can be up to about 30% by weight, in particular up to about 10% by weight.

An inventive stabilizer of the composition can moreover comprise lubricants, such as paraffin waxes, polyethylene waxes, polypropylene waxes, montan waxes, ester lubricants, such as fatty acid esters, purified or hydrogenated natural or synthetic triglycerides, or partial esters, amide waxes, chloroparaffins, glycerol esters, or alkaline earth metal soaps. Lubricants that can be used are also described in “Kunststoffadditive” [Plastics additives], R. Gächter and H. Müller, Carl Hanser Verlag, 3rd edition, 1989, pp. 478-488. Examples of other suitable additives of the fatty ketones described in DE 4,204,887, and also the silicone-based lubricants described by way of example in EP-A 0 259 783, or the combinations of these mentioned in EP-A 0 259 783. The documents mentioned are hereby expressly incorporated herein by way of reference, and their disclosure concerning lubricants is regarded as part of the disclosure of the present text. For the purposes of the present invention, particularly suitable lubricants are those of the Baerolub® product line from Baerlocher GmbH (Unterschleiβheim, Germany).

The amount present of the lubricants described in an inventive stabilizing position can be up to about 70% by weight, in particular up to about 40% by weight.

Equally suitable additives for stabilizer compositions of the present invention are organic plasticizers.

Examples of suitable plasticizers are compounds from the group of the phthalic esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzyl butyl, or diphenyl phthalate, and also mixtures of phthalates, for example mixtures of alkyl phthalates having from 7 to 9 or from 9 to 11 carbon atoms in the ester alcohol, or a mixture of alkyl phthalates having from 6 to 10 or from 8 to 10 carbon atoms in the ester alcohol. Particularly suitable compounds for the purposes of the present invention here are dibutyl, dihexyl, di-2-ethylhexyl, di-n-octyl, diisooctyl, diisononyl, diisodecyl, diisotridecyl, and benzyl butyl phthalate, and also the mixtures mentioned of alkyl phthalates.

Other suitable plasticizers are the esters of aliphatic dicarboxylic acids, in particular the esters of adipic, azeleic, or sebacic acid, or a mixture composed of two or more thereof. Examples of these plasticizers are di-2-ethylhexyl adipate, diisooctyl adipate, diisononyl adipate, diisodecyl adipate, benzyl butyl adipate, benzyl octyl adipate, di-2-ethylhexyl azelate, di-2-ethylhexyl sebacate, and diisodecyl sebacate. For the purposes of another embodiment of the present invention, preference is given to di-2-ethylhexyl acetate and diisooctyl adipate.

Equally suitable plasticizers are trimellitic esters, such as tri-2-ethylhexyl trimellitate, triisotridecyl trimellitate, triisooctyl trimellitate, and also trimellitic esters having from 6 to 8, from 6 to 10, from 7 to 9, or from 9 to 11 carbon atoms in the ester group, or in a mixture comprises of two or more of the compounds mentioned.

Examples of other suitable plasticizers are the polymeric plasticizers described in “Kunststoffadditive” [Plastics additives], R. Gächter and H. Müller, Carl Hanser Verlag, 3rd edition, 1989, chapter 5.9.6, pages 412-415, or “PVC Technology”, W. V. Titow, 4th edition, Elsevier Publishers, 1984, pages 165-170. Examples of the starting materials most commonly used for the preparation of polyester plasticizers are dicarboxylic acids, such as adipic, phthalic, azeleic, or sebacic acid, and diols, such as 1,2-propanediol, 1,3-butanediol, 1,4-butanediol, 1,6-hexanediol, neopentyl glycol, or diethylene glycol, or a mixture composed of two or more thereof.

Equally suitable plasticizers are the phosphoric esters found in “Taschenbuch der Kunststoffadditive” [Plastics additives handbook], chapter 5.9.5, pages 408-412. Examples of suitable phosphoric esters are tributyl phosphate, tri-2-ethylbutyl phosphate, tri-2-ethylhexyl phosphate, trichloroethyl phosphate, 2-ethylhexyl diphenyl phosphate, triphenyl phosphate, tricresyl phosphate, or trixylenyl phosphate, or a mixture composed of two or more thereof.

Other suitable plasticizers are chlorinated hydrocarbons (paraffins) or the hydrocarbons described in “Kunststoffadditive” [Plastics additives], R. Gächter and H. Müller, Carl Hanser Verlag, 3rd edition, 1989, chapter 5.9.14.2, pages 422-425 and chapter 5.9.14.1, page 422.

The amount that can be present of the plasticizers described in an inventive stabilizer composition is up to about 99.5% by weight, in particular up to about 30% by weight, up to about 20% by weight, or up to about 10% by weight. For the purposes of one preferred embodiment of the present invention, the lower limit for the plasticizers described as constituent of the inventive stabilizer compositions is 0.1% by weight or more, for example about 0.5% by weight, 1% by weight, 2% by weight, or 5% by weight.

Pigments are equally suitable as constituents of the inventive stabilizer compositions. Examples of suitable inorganic pigments are titanium dioxide, carbon black, Fe₂O₃, Sb₂O₃, (Ba, Sb)O₂, Cr₂O₃, spinells, such as cobalt blue and cobalt green, Cd (S, Se), or ultramarine blue. Examples of suitable organic pigments are azo pigments, phthalocyanine pigments, quinacridone pigments, perylene pigments, diketopyrrolopyrrol pigments, and anthraquinone pigments.

The inventive stabilizer composition can also comprise the fillers described in “Handbook of PVC Formulating”, E. J. Wickson, John Wiley & Sons, Inc., 1993, pages 393-449, or the reinforcing agents described in “Taschenbuch der Kunststoffadditive” [Plastics additives handbook], R. Gächter and H. Müller, Carl Hanser Verlag, 1990, pages 549-615. Examples of particularly suitable fillers or reinforcing agents are calcium carbonate (chalk), dolomite, wollastonite, magnesium oxide, magnesium hydroxide, silicate, glass fibers, talc, kaolin, carbon black, or graphite, woodflour, or other renewable raw materials. For the purposes of one preferred embodiment of the present invention, an inventive stabilizer composition comprises chalk.

For the purposes of another embodiment of the present invention, the inventive stabilizer compositions can comprise antioxidants, UV absorbers, and light stabilizers, or blowing agents. Examples of suitable antioxidants are described on pages 33 to 35 of EP-A 1 046 668. For the purposes of the present invention, preferred antioxidants used are the products in the Irganox® product line (producer: Ciba Specialty Chemicals), e.g. Irganox® 1010 or 1076, or products from the Lowinox produce line from Great Lakes.

Pages 35 and 36 of EP-A 1 046 668 mention suitable UV absorbers and light stabilizers. Both disclosures are expressly incorporated herein by way of reference, and these disclosures are regarded as part of the present text.

Examples of suitable blowing agents are organic azo and hydrazo compounds, tetrazoles, oxazines, isatoic anhydride, salts of citric acid, such as ammonium citrate, and also soda and sodium bicarbonate. Examples of particularly suitable compounds are ammonium citrate, azodicarbonamide, or sodium bicarbonate, or a mixture composed of two or more thereof.

An inventive stabilizer composition can also comprise impact modifiers and processing aids, gelling agents, antistatics, biocides, metal deactivators, optical brighteners, flame retardants, and antifogging compounds. Suitable compounds of these classes of compound are described by way of example in “Kunststoff Additive” [Plastics additives], R. Keβler and H. Müller, Carl Henser Verlag, 3rd edition, 1989, and in “Handbook of PVC Formulating”, E. J. Wilson, J. Wiley & Sons, 1993.

The present invention therefore also provides a stabilizer composition at least comprising a salt production corresponding to the present invention and at least one further additive.

Alongside the inventive stabilizer composition itself, the process for its production is also provided by the present invention.

The present invention therefore also provides a process for the production of a stabilizer composition, characterized in that an inventive salt production or a salt production produced according to the invention and at least one further additive are mixed.

The inventive stabilizer compositions are suitable, for example, for the stabilization of halogen-containing polymers.

Examples of these halogen-containing polymers are polymers of vinyl chloride, vinyl resins which contain vinyl chloride units in the main polymer chain, copolymers of vinyl chloride and of vinyl esters of aliphatic acids, in particular vinyl acetate, copolymers of vinyl chloride with esters of acrylic and methacrylic acid, or acrylonitrile, or with mixtures composed of two or more thereof, the polymers of vinyl chloride with diene compounds or with unsaturated dicarboxylic acids, or with their anhydrides, for example copolymers of vinyl chloride with diethyl maleate, diethyl fumarate, or maleic anhydride, post-chlorinated polymers and copolymers of vinyl chloride, copolymers of vinyl chloride and of vinylidene chloride with unsaturated aldehydes, with ketones, and with other compounds, such as acrolein, crotonaldehydes, vinyl methyl ketone, vinyl methyl ether, vinyl isobutyl ether, and the like, polymers and copolymers of vinylidene chloride with vinyl chloride and with the other abovementioned polymerizable compounds, polymers of vinyl chloroacetate and of dichlorodivinyl ether, chlorinated polymers or vinyl acetate, chlorinated polymeric esters of acrylic acid and of α-substituted acrylic acids, chlorinated with polystyrenes, such as polydichlorostyrene, chlorinated polymers of ethylene, polymers and post-chlorinated polymers or chlorbutadiene and their copolymers with vinyl chloride, and mixtures composed of two or more of the polymers mentioned, or polymer mixtures which comprise one or more of the abovementioned polymers. For the purposes of one preferred embodiment of the present invention, the inventive stabilizer compositions are used for the production of moldings composed of PVCU, e.g. window profiles, technical profiles, pipes, and sheets.

The graft polymers of PVC with EVA, ABS, or MBS are equally suitable for stabilization by the inventive stabilizer compositions. Other preferred substrates for these graft polymers are the abovementioned homo- and copolymers, in particular mixtures of vinyl chloride homopolymers with other thermoplastic or elastomeric polymers, in particular blends with ABS, MBS, NBR, SAN, EVA, CPE, MBAS, PAA (polyalkyl acrylate), PAMA (polyalkyl methacrylate), EPDM, polyamides, or polylactones.

Mixtures of halogenated and nonhalogenated polymers are equally suitable for stabilization by the inventive stabilizer compositions, examples being mixtures of the abovementioned nonhalogenated polymers with PVC, in particular mixtures of polyurethanes and PVC.

Recycled materials derived from chlorine-containing polymers can also be stabilized by the inventive stabilizer compositions, and in principle any of the recycled materials derived from the abovementioned, halogenated polymers are suitable for this purpose. An example of a suitable material for the purposes of the present invention is recycled PVC.

The present invention therefore also provides a polymer composition at least comprising a halogen-containing polymer and an inventive salt preparation, or a salt preparation produced according to the invention, or an inventive salt preparation or a stabilizer composition produced according to the invention.

For the purposes of one preferred embodiment of the present invention, an inventive polymer composition comprises an amount of from 0.1 to 20 phr, in particular from about 0.5 to about 15 phr or from about 1 to about 12 phr, of the inventive stabilizer composition. The unit phr is “per hundred resin” and therefore relates to parts by weight per 100 parts by weight of polymer.

An inventive polymer composition preferably comprises, as a halogenated polymer, at least some content of PVC, and the PVC content here is in particular at least about 20% by weight, preferably at least about 50% by weight, for example at least about 80% by weight or at least about 90% by weight.

The present invention also provides a process for the stabilization of halogen-containing polymers, in which a halogen-containing polymer or a mixture composed of two or more halogen-containing polymers, or a mixture composed of one or more halogen-containing polymers and of one or more halogen-free polymers is mixed with an inventive stabilizer composition.

The mixing of polymers or of polymers and the inventive stabilizer composition can in principle take place at any desired juncture prior to or during the processing of the polymer. By way of example, the stabilizer composition can be admixed, prior to processing, with the polymer present in the form of powder or of pellets. However, it is equally possible that the stabilizer composition is added to the polymer(s) in the softened or moltened state, for example during processing in an extruder, in the form of emulsion or as dispersion, as a paste-like mixture, as a dry mixture, as a solution, or as a melt.

The present invention therefore also provides a process for the stabilization of halogen-containing polymers, in which a halogen-containing polymer or a mixture comprised of two or more halogen-containing polymers, or a mixture composed of one or more halogen-containing polymers and of one or more halogen-free polymers is mixed with an inventive salt preparation with a salt preparation produced according to the invention, or with an inventive stabilizer composition, or with a stabilizer composition produced according to the invention.

An inventive polymer composition can be converted in a known manner to a desired form. Examples of suitable processes are calendaring, extruder, injection molding, sintering, extrusion blow molding, or the plastisol process. An inventive polymer composition can, for example, also be used for the production of foams. In principle, the inventive polymer compositions are suitable for the production of rigid or flexible PVC, in particular for the production of PVCU.

An inventive polymer composition can be processed to give moldings. The present invention therefore also provides moldings, at least comprising an inventive salt preparation or a salt preparation produced according to the invention, or an inventive stabilizer composition, or a stabilizer composition produced according to the invention, or an inventive polymer composition.

For the purposes of the present invention, the expression “molding” encompasses in principle any of the three-dimensional structures which can be produced from an inventive polymer composition. For the purposes of the present invention, the expression “molding” encompasses by way of example wire sheathing, automobile components, such as the automobile components used in the interior of the automobile, in the engine compartment, or on the outer surfaces, cable insulation, decorative foils, agricultural foils, hoses, sealing profiles, office foils, hollow products (bottles), packaging foils (thermoforming foils), blown foils, pipes, foams, heavy-duty profiles (window frames), thin-wall profiles, construction profiles, sidings, fittings, foam sheets and other sheets, coextrudates with recycled core, or housings for electrical apparatuses or machines, for example computers or household devices.

Other examples of moldings that can be produced from an inventive polymer composition are synthetic leather, floor coverings, textile coatings, wallpapers, coil coatings, or underbody protection for motor vehicles.

Examples are used below for further illustration of the invention.

### EXAMPLE I

### 1. Production of Comparative Examples (CE)

For the comparative examples, physical mixtures corresponding to table 1 were manufactured. The amounts used of the alkaline earth metal/alkali metal perchlorates correspond to identical perchlorate contents of the finished mixtures.

TABLE 1
Constitution of comparative examples

| | CE 1 | CE 2 | CE 3 | CE 4 | CE 5 |
|---|---|---|---|---|---|
| Trimethylolpropane | | 10 g | 10 g | 10 g | |
| BS ASM 711¹ | 10 g | | | | |
| Cyanoguanidine | | 5 g | | | |
| N,N′-Dimethylurea | | | 5 g | 5 g | |
| Lithium perchlorate | | 8.7 g | 8.7 g | | |
| Sodium perchlorate² | | | | | 10 g |
| Calcium perchlorate³ | | | | 12.7 g | |
| Triethanolamine | | | | | 10 g |

¹Trade name of Baerlocher GmbH, perchlorate content 10%
²Monohydrate
³Tetrahydrate

### 2. Production of Inventive Example (IE)

The inventive examples were produced as follows. Mixtures corresponding to table 2 were heated up to the melting point of the organic component(s) and stirred at this temperature until a homogeneous liquid phase formed. They were then slowly cooled to room temperature. The resultant solid stabilizer preparations were milled prior to testing. The amounts used of the alkaline earth metal/alkali metal perchlorates correspond to identical perchlorate contents of the finished mixtures.

TABLE 2
Constitution of inventive examples

| | IE 1 | IE 2 | IE 3 | IE 4 | IE 5 | IE 6 | IE 7 |
|---|---|---|---|---|---|---|---|
| Trimethylol-propane | 10.0 g | 10.0 g | 10.0 g | 10.0 g | 10.0 g | 10.0 g | 10.0 g |
| PEG 20,000¹ | | | | | | | |
| Lithium | | 8.70 g | 8.70 g | 8.70 g | | | |
| perchlorate | | | | | | | |
| Sodium | | | | | | | |
| perchlorate² | | | | | | | |
| Calcium | 12.7 g | | | | 12.7 g | 12.7 g | 12.7 g |
| perchlorate³ | | | | | | | |
| Cyanoguanidine | | 5.00 g | | | 5.00 g | | |
| N,N′-Dimethylurea | | | 5.00 g | | | | |
| Acetamide | | | | 5.00 g | | 5.00 g | |
| 2-Pyrrolidone | | | | | | | 5.00 g |
| Triethanolamine | | | | | | | |
| Epoxide⁴ | 5.00 g | | | | | | |
| | IE 8 | IE 9 | IE 10 | IE 11 | IE 12 | IE 13 | IE 14 |
| Trimethylol-propane | | | | | | | |
| PEG 20,000¹ | 10.0 g | 10.0 g | 10.0 g | | | | |
| Lithium | | 8.70 g | | | 1.74 g | | |
| perchlorate | | | | | | | |
| Sodium | 10.0 g | | | 2.00 g | | | 10.0 g |
| perchlorate² | | | | | | | |
| Calcium | | | 12.7 g | | | 2.54 g | |
| perchlorate³ | | | | | | | |
| Cyanoguanidine | 5.00 g | 5.00 g | 5.00 g | 10.0 g | 10.0 g | 10.0 g | |
| N,N′-Dimethylurea | | | | | | | |
| Acetamide | | | | | | | |
| 2-Pyrrolidone | | | | | | | |
| Triethanolamine | | | | | | | 10.0 g |
| Epoxide⁴ | | | | | | | |

¹Trade name of Merck
²Monohydrate
³Tetrahydrate
⁴Bisphenol A diglycidyl ether

### 3. Test Method

Mixing rolls were used to mill dry mixes for 3 minutes at 180° C., corresponding to the test formulation mentioned below and stabilizers of table 3. The milled sheets were used to produce pressed sheets of thickness 1 mm for the color measurements. The HCl data were determined by means of a Congo red test.

TABLE 3
Test results

| Stabilizer* | HCl (min) | Initial color (L*, a*, b*) | | | Evaluation |
|---|---|---|---|---|---|
| IE 1 | 16 | 58.5 | 17.3 | 31.0 | ∘ |
| IE 2 | 17 | 70.2 | 6.8 | 45.1 | ∘ |
| IE 3 | 18 | 68.1 | 11.1 | 47.0 | ∘ |
| IE 4 | 17 | 67.8 | 9.7 | 44.9 | ∘ |
| IE 5 | 14 | 64.4 | 15.8 | 35.9 | ∘ |
| CE 1 | 20 | 73.6 | 0.9 | 34.1 | ++ |
| CE 2 | 18 | 73.5 | −0.5 | 35.9 | ++ |
| CE 3 | 20 | 68.4 | 5.8 | 40.4 | + |
| CE 4 | 17 | 70.4 | 5.6 | 40.6 | + |
| CE 5 | 19 | 73.8 | −1.3 | 31.5 | ++ |
| CE 6 | 18 | 71.2 | 4.2 | 40.9 | + |
| CE 7 | 19 | 72.0 | 4.2 | 40.8 | + |
| CE 8 | 16 | 69.7 | 5.3 | 44.1 | + |
| CE 9 | 16 | 69.4 | 5.1 | 42.0 | + |
| CE 10 | 16 | 70.3 | 4.8 | 42.6 | + |
| CE 11 | 17 | 69.7 | −0.2 | 33.9 | + |
| CE 12 | 16 | 73.5 | −0.5 | 30.6 | + |
| CE 13 | 16 | 71.9 | −0.0 | 35.6 | + |
| CE 14 | 19 | 70.9 | 1.8 | 35.5 | ++ |

As clearly discernible, thermal stability and initial color (a* value) is improved via the inventive stabilizers.

TABLE 3
Test results

| Stabilizer* | HCl (min) | Initial color (L*, a*, b*) | | | Evaluation |
|---|---|---|---|---|---|
| IE 1 | 16 | 58.5 | 17.3 | 31.0 | ∘ |
| IE 2 | 17 | 70.2 | 6.8 | 45.1 | ∘ |
| IE 3 | 18 | 68.1 | 11.1 | 47.0 | ∘ |
| IE 4 | 17 | 67.8 | 9.7 | 44.9 | ∘ |
| IE 5 | 14 | 64.4 | 15.8 | 35.9 | ∘ |
| CE 1 | 20 | 73.6 | 0.9 | 34.1 | ++ |
| CE 2 | 18 | 73.5 | −0.5 | 35.9 | ++ |
| CE 3 | 20 | 68.4 | 5.8 | 40.4 | + |
| CE 4 | 17 | 70.4 | 5.6 | 40.6 | + |
| CE 5 | 19 | 73.8 | −1.3 | 31.5 | ++ |
| CE 6 | 18 | 71.2 | 4.2 | 40.9 | + |
| CE 7 | 19 | 72.0 | 4.2 | 40.8 | + |
| CE 8 | 16 | 69.7 | 5.3 | 44.1 | + |
| CE 9 | 16 | 69.4 | 5.1 | 42.0 | + |
| CE 10 | 16 | 70.3 | 4.8 | 42.6 | + |
| CE 11 | 17 | 69.7 | −0.2 | 33.9 | + |
| CE 12 | 16 | 73.5 | −0.5 | 30.6 | + |
| CE 13 | 16 | 71.9 | −0.0 | 35.6 | + |
| CE 14 | 19 | 70.9 | 1.8 | 35.5 | ++ |

As clearly disernible, thermal stability and initial color (a* value) is improved via the inventive stabilizers.

### EXAMPLE II

### Production of Complex-Cation Perchlorates, Taking Triethanolamine Calcium Perchlorate as Example

15.55 g of calcium perchlorate tetrahydrate (0.05 mmol) were slowly added to 14.91 g (0.1 mol) of triethanolamine. Cooling to room temperature gave the product in the form of crystalline, white solid.

1. A salt preparation at least comprising a salt of a halogen-containing oxy acid or a mixture composed of two or more salts of halogen-containing oxy acids and a solvent or a mixture composed of two or more solvents, where the salt of a halogen-containing oxy acid or the mixture composed of two or more salts of halogen-containing oxy acids is soluble in the solvent or the mixture composed of two or more solvents at 20° C. to an extent of at least 0.1% by weight, based on the solvent or the mixture composed of two or more solvents, and the salt preparation is solid at 5° C., where the cation of the salt of the halogen-containing oxy acid has been selected from the group consisting of Li, Na, K, Mg, Ca, Sr, Zn, Al, La, or Ce.

2-17. (canceled)

18. The salt preparation as claimed in claim 1 wherein the salt preparation comprises at least one organic solvent.

19. The salt preparation as claimed in claim 1 wherein the salt preparation comprises at least one polar organic solvent.

20. The salt preparation as claimed in claim 1 wherein the salt preparation comprises at least one polyol as solvent.

21. The salt preparation as claimed in claim 1 wherein the salt preparation comprises at least one amino alcohol as solvent.

22. The salt preparation as claimed in claim 1 wherein the salt preparation encompasses triethanolamine as solvent.

23. The salt preparation as claimed in claim 1 wherein the salt preparation comprises solvent molecules complexing at least one salt of a halogen-containing oxy acid, where solvent molecules complex at least one cation or at least one anion or at least one cation and at least one anion of one or more salts of halogen-containing oxy acids.

24. A salt preparation, which can be produced via the mixing of a salt of a halogen-containing oxy acid or of a mixture composed of two or more salts of halogen-containing oxy acids with a solvent or with a mixture composed of two or more solvents, where at least 0.1% by weight of the salt of a halogen-containing oxy acid or of the mixture composed of two or more salts of halogen-containing oxy acids, based on the solvent or the mixture composed of two or more solvents, is dissolved in this and the salt preparation becomes solid at 5° C., where the cation of the salt of the halogen-containing oxy acid has been selected from the group consisting of Li, Na, K, Mg, Ca, Sr, Zn, Al, La, or Ce.

25. A process for the production of a salt preparation as claimed in 1 which is solid at 5° C. wherein by virtue of the mixing of a salt of a halogen-containing oxy acid or of a mixture composed of two or more salts of halogen-containing oxy acids with a solvent or with a mixture composed of two or more solvents, at least 0.1% by weight of the salt of a halogen-containing oxy acid or of the mixture composed of two or more salts of halogen-containing oxy acids, based on the solvent or the mixture composed of two or more solvents, is dissolved.

26. The process as claimed in claim 25 wherein the salt of a halogen-containing oxy acid or the mixture composed of two or more salts of halogen-containing oxy acid is, by virtue of mixing with a liquid solvent or with a mixture composed of two or more liquid solvents, dissolved to an extent of at least 0.1% by weight, based on the solvent or the mixture composed of two or more solvents, and by virtue of this the salt preparation becomes solid.

27. The process as claimed in claim 25 wherein
a. the solvent or the mixture composed of two or more solvents is melted by heating,
b. the salt of a halogen-containing oxy acid or the mixture composed of two or more salts of halogen-containing oxy acids is, by virtue of mixing with the solvent or with the mixture composed of two or more solvents, dissolved in this to an extent of at least 0.1% by weight, based on the solvent or the mixture composed of two or more solvents, and
c. the resultant salt preparation is cooled,
and by virtue of this the salt preparation becomes solid.

28. A stabilizer composition at least comprising a salt preparation as claimed in claim 1 and at least one further additive.

29. A stabilizer composition at least comprising a salt preparation as claimed in claim 24 and at least one further additive.

30. The stabilizer composition as claimed in claim 28 wherein the salt preparation is substantially free from further inorganic additives,

31. A process for the production of a stabilizer composition wherein a salt preparation as claimed in claim 1 and at least one further additive are mixed.

32. A polymer composition, at least comprising a halogen-containing polymer and a salt preparation as claimed in claim 1.

33. A process for the stabilization of halogen-containing polymers, in which a halogen-containing polymer or a mixture composed of two or more halogen-containing polymers or a mixture composed of one or more halogen-containing polymers and of one or more halogen-free polymers is mixed with a salt preparation as claimed in claim 1.

34. A molding, at least comprising a salt preparation as claimed in claim 1.

35. A stabilizer composition at least comprising a salt preparation produced by a process as claimed in claim 25 and at least one further additive.

36. A process for the stabilization of halogen-containing polymers, in which a halogen-containing polymer or a mixture composed of two or more halogen-containing polymers or a mixture composed of one or more halogen-containing polymers and one or more halogen-free polymers is mixed with a salt preparation produced by a process as claimed in claim 25.

37. A halogen-containing polymer composition, at least comprising a halogen-containing polymer and a salt preparation produced by a process as claimed in claim 25.

38. A halogen-containing polymer composition, at least comprising a halogen-containing polymer and a stabilizer composition as claimed in claim 28.

39. A halogen-containing polymer composition, at least comprising a halogen-containing polymer and a stabilizer composition produced by the process as claimed in claim 31.

40. A process for the stabilization of halogen-containing polymers in which a halogen-containing polymer or a mixture composed of two or more halogen-containing polymers or a mixture composed of one or more halogen-containing polymers and of one or more halogen-free polymers is mixed with a preparation produced by a process as claimed in claim 25.

41. A process for the stabilization of halogen-containing polymers, in which a halogen-containing polymer or a mixture composed of two or more halogen-containing polymers or a mixture composed of one or more halogen-containing polymers and of one or more halogen-free polymers is mixed with a stabilizer composition as claimed in claim 28.

42. A process for the stabilization of halogen-containing polymers, in which a halogen-containing polymer or a mixture composed of two or more halogen-containing polymers or a mixture composed of one or more halogen-containing polymers and of one or more halogen-free polymers is mixed with a stabilizer composition produced by the process as claimed in claim 31.

43. A molding, at least comprising a salt preparation produced by a process as claimed in claim 25.

44. A molding, at least comprising a stabilizer composition as claimed in claim 28.

45. A molding, at least comprising a stabilizer composition produced by a process as claimed in claim 31.

46. A molding, at least comprising a polymer composition as claimed in claim 32.
